(19) United States
(12) Patent Application Publication
(10) Pub. No.: US 2022/0001450 A1
(43) Pub. Date: Jan. 6, 2022

(54) THREE-DIMENSIONAL FABRICATION APPARATUS

(71) Applicant: Yohei OSANAI, Kanagawa (JP)

(72) Inventor: Yohei OSANAI, Kanagawa (JP)

(73) Assignee: Ricoh Company, Ltd., Tokyo (JP)

(21) Appl. No.: 17/324,603

(22) Filed: May 19, 2021

(30) Foreign Application Priority Data
Jul. 2, 2020 (JP) 2020-115243

(51) Int. Cl. B22F 10/34; B22F 10/14; B22F 12/57; B22F 10/28; B33Y 30/00; B33Y 50/02; B29C 64/165; B29C 64/393

(52) U.S. Cl. CPC B22F 10/34; B22F 10/14; B22F 12/57; B29C 64/393; B33Y 30/00; B33Y 50/02; B29C 64/165; B22F 10/28

(57) ABSTRACT

A three-dimensional fabrication apparatus includes a fabrication chamber in which a fabrication object is formed, a powder supply unit configured to supply powder to the fabrication chamber, a driver configured to scan the powder supply unit above the fabrication chamber, a measurement unit configured to measure a powder supply amount, the powder supply amount being an amount of the powder supplied from the powder supply unit to the fabrication chamber, and circuitry configured to perform a feedback control to control a fluctuation amount of the powder supply amount to be smaller than a preset amount based on the powder supply amount measured by the measurement unit.

### CROSS-REFERENCE TO RELATED APPLICATION

This patent application is based on and claims priority pursuant to 35 U.S.C. § 119(a) to Japanese Patent Application No. 2020-115243, filed on Jul. 2, 2020, in the Japan Patent Office, the entire disclosures of which is hereby incorporated by reference herein.

### BACKGROUND

### Technical Field

Aspects of the present disclosure relate to a three-dimensional fabrication apparatus.

### Related Art

A three-dimensional (3D) printer as an example of a three-dimensional fabrication apparatus includes a powder bed. A hopper supply method is used as a technique to supply powder to a powder layer in a fabrication chamber. The hopper supply method supplies the powder to the powder layer while moving the hopper above the powder layer.

### SUMMARY

In an aspect of this disclosure, a three-dimensional fabrication apparatus includes a fabrication chamber in which a fabrication object is formed, a powder supply unit configured to supply powder to the fabrication chamber, a driver configured to scan the powder supply unit above the fabrication chamber, a measurement unit configured to measure a powder supply amount, the powder supply amount being an amount of the powder supplied from the powder supply unit to the fabrication chamber, and circuitry configured to perform a feedback control to control a fluctuation amount of the powder supply amount to be smaller than a preset amount based on the powder supply amount measured by the measurement unit.

### BRIEF DESCRIPTION OF THE SEVERAL VIEWS OF THE DRAWINGS

The aforementioned and other aspects, features, and advantages of the present disclosure will be better understood by reference to the following detailed description when considered in connection with the accompanying drawings, wherein:

FIG. 1 is a schematic side view of an example of a three-dimensional fabrication apparatus in a first comparative example;

FIG. 2A is a schematic side view of the three-dimensional fabrication apparatus in the first comparative example illustrating an example of a flow of a fabrication process of a fabrication object in the three-dimensional fabrication apparatus;

FIG. 2B is a schematic side view of the three-dimensional fabrication apparatus in the first comparative example illustrating an example of a flow of a fabrication process of a fabrication object in the three-dimensional fabrication apparatus;

FIG. 2C is a schematic side view of the three-dimensional fabrication apparatus in the first comparative example illustrating an example of a flow of a fabrication process of a fabrication object in the three-dimensional fabrication apparatus;

FIG. 2D is a schematic side view of the three-dimensional fabrication apparatus in the first comparative example illustrating an example of a flow of a fabrication process of a fabrication object in the three-dimensional fabrication apparatus;

FIG. 2E is a schematic side view of the three-dimensional fabrication apparatus in the first comparative example illustrating an example of a flow of a fabrication process of a fabrication object in the three-dimensional fabrication apparatus;

FIG. 2F is a schematic side view of the three-dimensional fabrication apparatus in the first comparative example illustrating an example of a flow of a fabrication process of a fabrication object in the three-dimensional fabrication apparatus;

FIG. 2G is a schematic side view of the three-dimensional fabrication apparatus in the first comparative example illustrating an example of a flow of a fabrication process of a fabrication object in the three-dimensional fabrication apparatus;

FIG. 2H is a schematic side view of the three-dimensional fabrication apparatus in the first comparative example illustrating an example of a flow of a fabrication process of a fabrication object in the three-dimensional fabrication apparatus;

FIG. 3A is a schematic cross-sectional side view of a powder and a fabrication liquid illustrating an example of the powder used in the fabrication process of the three-dimensional fabrication apparatus;

FIG. 3B is a schematic cross-sectional side view of the powder and the fabrication liquid illustrating an example of the powder used in the fabrication process of the three-dimensional fabrication apparatus;

FIG. 3C is a schematic cross-sectional side view of the powder and the fabrication liquid illustrating an example of the powder used in the fabrication process of the three-dimensional fabrication apparatus;

FIG. 4 is a schematic side view of a hopper-type powder supply unit of the three-dimensional fabrication apparatus according to a second comparative example;

FIG. 5A is a schematic side view of the powder supply unit illustrating an example of advantages and disadvantages of the hopper-type powder supply unit;

FIG. 5B is a schematic side view of the powder supply unit illustrating an example of advantages and disadvantages of the hopper-type powder supply unit;

FIG. 6 is a schematic side view of the three-dimensional fabrication apparatus according to the present embodiment to illustrate an example of a measurement process of a powder supply amount in the three-dimensional fabrication apparatus;

FIG. 7 is a schematic side view of the powder supply unit to illustrate an example of a supply process of the powder to a fabrication chamber in the three-dimensional fabrication apparatus according to the present embodiment;

FIG. 8 is a flowchart of an example of a flow of a fabrication process by the three-dimensional fabrication apparatus according to the present embodiment;

FIG. 9 is a flowchart of an example of a flow of a feedback control process of the powder supply amount in the three-dimensional fabrication apparatus in the present embodiment; and

FIG. 10 is a graph illustrating an example of a calculation result of the powder supply amount of the powder by the three-dimensional fabrication apparatus according to the present embodiment.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner, and achieve similar results.

Although the embodiments are described with technical limitations with reference to the attached drawings, such description is not intended to limit the scope of the disclosure and all of the components or elements described in the embodiments of this disclosure are not necessarily indispensable. As used herein, the singular forms “a,” “an,” and “the” are intended to include the plural forms as well, unless the context clearly indicates otherwise.

Hereinafter, embodiments of a three-dimensional fabrication apparatus 500 are described below in detail with reference to the accompanying drawings.

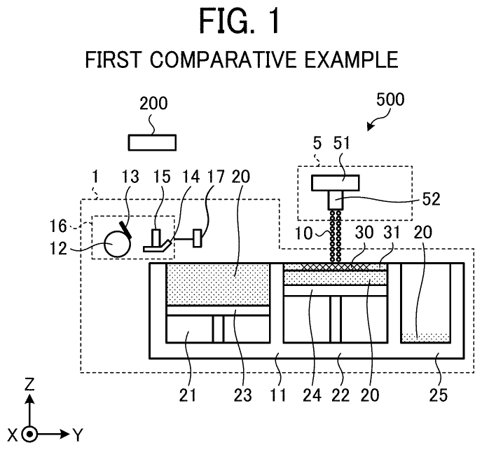

FIG. 1 is a schematic side view of an example of the three-dimensional fabrication apparatus 500 in a first comparative example. First, an example of a schematic configuration of a three-dimensional fabrication apparatus (powder lamination fabrication apparatus) in the first comparative example is described below with reference to FIG. 1.

The three-dimensional fabrication apparatus 500 includes a fabrication unit 1 and an application unit 5. The fabrication unit 1 forms a fabrication layer 30 that is a fabrication object including layers of bonded powders 20. The application unit 5 applies a fabrication liquid 10 onto a powder layer 31 spread in layers in the fabrication unit 1 to fabricate a three-dimensional fabrication object.

The fabrication unit 1 includes a powder chamber 11 and a lamination unit 16. The lamination unit 16 includes a flattening roller 12, a powder removal plate 13, a vibration blade 14, and an actuator 15. The flattening roller 12 is a rotating body as a flattening device (recoater). The vibration blade 14 is a tapping device to tap the powder 20 in the powder layer 31 and vibrates in the Z direction (vertical direction) as indicated by arrow “Z” in FIG. 1.

The actuator 15 drives the vibration blade 14. The flattening device (recoater) may include a plate (blade or bar) instead of the rotating body such as the flattening roller 12, for example. As the actuator 15 of the vibration blade 14, an air vibrator, an eccentric motor, a laminated piezoelectric element, or the like can be used. Here, the lamination unit 16 is presumed to use the vibration blade 14 to tap the powder 20 in the powder layer 31. However, the lamination unit 16 may not necessarily use the vibration blade 14 when the density of the powder layer 31 is originally high.

The powder chamber 11 includes a supply chamber 21, a fabrication chamber 22, and a surplus-powder receiving chamber 25. The supply chamber 21 is a chamber to supply the powder 20 to the fabrication chamber 22. Fabrication layers 30 are laminated in the fabrication chamber 22 so that the three-dimensional fabrication object is fabricated in the fabrication chamber 22. The surplus-powder receiving chamber 25 accumulates a surplus powder 20 fallen from the fabrication chamber 22. The surplus powder 20 is the powder 20 supplied to and fallen from the fabrication chamber 22 by the flattening roller 12 during forming a new powder layer 31 in the fabrication chamber 22.

The supply chamber 21 includes a supply stage 23 on a bottom of the supply chamber 21. The supply stage 23 is vertically movable in the Z direction (height direction). Similarly, the fabrication chamber 22 includes a fabrication stage 24 on a bottom of the fabrication chamber 22. The three-dimensional object including a lamination of the fabrication layers 30 is fabricated on the fabrication stage 24. The surplus-powder receiving chamber 25 may have a configuration including a mechanism to attract the powder 20 to a bottom of the surplus-powder receiving chamber 25 or a configuration in which the surplus-powder receiving chamber 25 is removable in simple manner.

The fabrication unit 1 includes a motor that moves the supply stage 23 and the fabrication stage 24 in the Z direction (height direction), for example. The flattening roller 12 transfers and supplies the powder 20 supplied onto the supply stage 23 in the supply chamber 21 to the fabrication chamber 22. The flattening roller 12 evens and flattens a surface of the powder 20 in the fabrication chamber 22 to form the powder layer 31.

The flattening roller 12 is disposed to be relatively reciprocally movable with respect to a stage surface (a surface on which the powder 20 is stacked) of the fabrication stage 24 along a “Y” direction indicated by arrow Y in FIG. 1. The Y direction is a horizontal direction along the stage surface of the fabrication stage 24. The flattening roller 12 is rotationally driven by a motor.

On the other hand, the application unit 5 includes a carriage 51 and a liquid application head 52 (liquid discharge head). The liquid application head 52 applies (discharges) the fabrication liquid 10 onto the powder layer 31 on the fabrication stage 24. Hereinafter, the liquid application head 52 is simply referred to as a “head 52”. The carriage 51 mounts at least one of the head 52. The carriage 51 is reciprocally movable in a X direction (main scanning direction), the Y direction (sub scanning direction), and the Z directions (height direction) by a motor, a guide, and the like.

Each head 52 is an inkjet head and has a nozzle array in which the nozzles from which the liquid is discharged to apply liquid onto the powder 20 are arranged on a nozzle surface of the head 52. The head 52 discharges a liquid from the nozzles in the nozzle array to apply the liquid onto the powders 20 in the fabrication chamber 22. A configuration of the head is not limited to embodiments as described above.

The application unit 5 may include four heads 52 to discharge and apply the fabrication liquid of cyan, magenta, yellow, and black onto the powder 20 in the fabrication chamber 22 to fabricate a color fabrication object. An inkjet method using the head 52 is largely used as a method for applying the fabrication liquid 10 onto the powder 20. However, a dispenser method or the like may be used to apply the fabrication liquid 10 onto the powder 20.

A specific configuration of the fabrication unit 1 is further described below.

The powder chamber 11 has a boxed shape. The powder chamber 11 includes three chambers each of which includes an opened top surface. Specifically, the powder chamber 11 includes the supply chamber 21, the fabrication chamber 22, and the surplus-powder receiving chamber 25. The supply chamber 21 includes the supply stage 23 inside the supply chamber 21.

The supply stage 23 is vertically movable (move upward and downward) in the supply chamber 21. Similarly, the fabrication chamber 22 includes the fabrication stage 24 inside the fabrication chamber 22. The fabrication stage 24 is vertically movable (move upward and downward) in the fabrication chamber 22.

Side surfaces of the supply stage 23 are arranged to be in contact with an inner side surfaces of the supply chamber 21. Side surfaces of the fabrication stage 24 are arranged to be in contact with an inner side surfaces of the fabrication chamber 22. The upper surfaces of the supply stage 23 and fabrication stage 24 are kept horizontal.

The fabrication unit 1 includes the surplus-powder receiving chamber 25 next to the fabrication chamber 22. In FIG. 1, the surplus-powder receiving chamber 25 is arranged at right end of the powder chamber 11. Thus, the fabrication chamber 22 is disposed between the supply chamber 21 and the surplus-powder receiving chamber 25. The surplus-powder receiving chamber 25 receives a surplus powder 20 fallen from the fabrication chamber 22 among the powder 20 supplied by the by the flattening roller 12 during forming the powder layer 31 in the fabrication chamber 22.

The surplus powder 20 fallen into the surplus-powder receiving chamber 25 is returned to a powder supply unit 100 (see FIG. 4, for example) to supply the powder 20 to the supply chamber 21. The powder supply unit 100 is disposed above the supply chamber 21. The powder supply unit 100 supplies the powder 20 accumulated in a tank and the like in the powder supply unit 100 to the supply chamber 21 at a time of an initial operation of a fabrication process or when an amount of the powder 20 in the supply chamber 21 decreases.

Examples of a powder conveyance method to supply the powder 20 to the supply chamber 21 include a screw conveyance system using a screw and an air conveyance system using air.

The flattening roller 12 transfers and supplies the powder 20 from the supply chamber 21 to the fabrication chamber 22. Further, the flattening roller 12 flattens and levels a surface of laminated powder 20 to form a powder layer 31 which is a layered powder 20 having a predetermined thickness.

The flattening roller 12 is a rod having length larger than an inner dimension of the fabrication chamber 22 and the supply chamber 21. Each of the inner dimension of the fabrication chamber 22 and the supply chamber 21 is a width of a portion to which the powder 20 is supplied or filled. The flattening roller 12 is reciprocally moved along a stage surface of the fabrication chamber 22 in the Y direction (sub-scanning direction).

Further, the flattening roller 12 horizontally moves to pass through an area above the supply chamber 21 and the fabrication chamber 22 from an outside of the supply chamber 21 while being rotated by the motor. Thus, the powder 20 is transferred and supplied into the fabrication chamber 22. Further, the flattening roller 12 flattens the powder 20 while passing over the fabrication chamber 22, thus forming the powder layer 31.

Further, the lamination unit 16 a powder removal plate 13 that is a powder remover in contact with a peripheral surface of the flattening roller 12 to remove the powder 20 adhered to the flattening roller 12. The powder removal plate 13 moves together with the flattening roller 12 in contact with the peripheral surface of the flattening roller 12. The powder removal plate 13 may be oriented in any of a following direction and a counter direction with respect to a direction of rotation of the flattening roller 12 to flatten the powder 20.

In the three-dimensional fabrication apparatus 500 in the first comparative example, the powder chamber 11 of the fabrication unit 1 includes two chambers of the supply chamber 21 and the fabrication chamber 22. However, the powder chamber 11 may include only the fabrication chamber 22, and the powder 20 may be supplied from the powder supply unit 100 to the fabrication chamber 22 and flattened by the flattening roller 12 as illustrated in FIG. 4.

The three-dimensional fabrication apparatus 500 includes a controller 200 that receives fabrication data from a fabrication data generation apparatus such as an external personal computer. The controller 200 includes circuitry such as a central processing unit (CPU), a read-only memory (ROM), a random-access memory (RAM), and the like. The CPU controls the entire three-dimensional fabrication apparatus 500.

The ROM stores programs to cause the CPU to perform the control of such as a fabrication operation, and other fixed data. The RAM temporarily stores fabrication data and the like. A fabrication data generating apparatus generates fabrication data in which a final-form object (three-dimensional object) is virtually sliced into multiple fabrication layers 30. The controller 200 performs a fabrication operation for each fabrication layer 30.

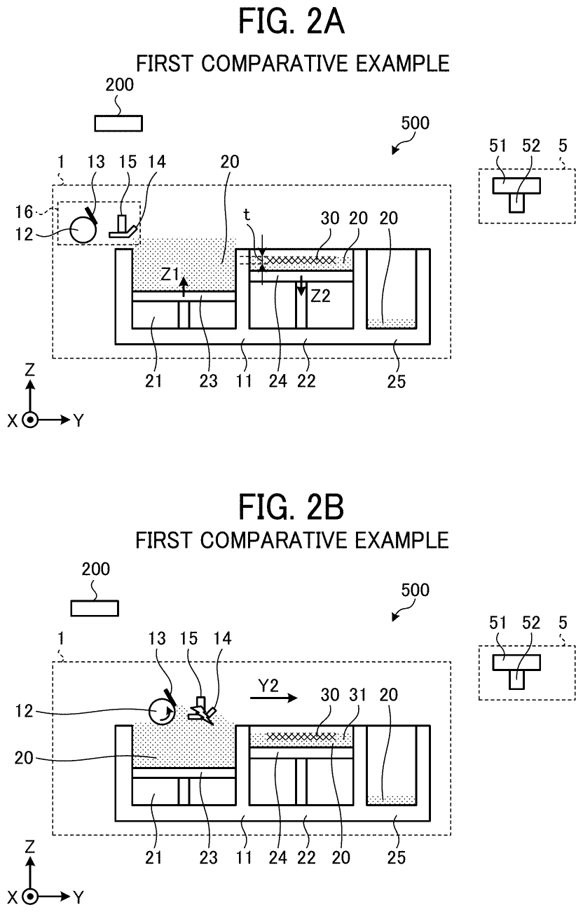

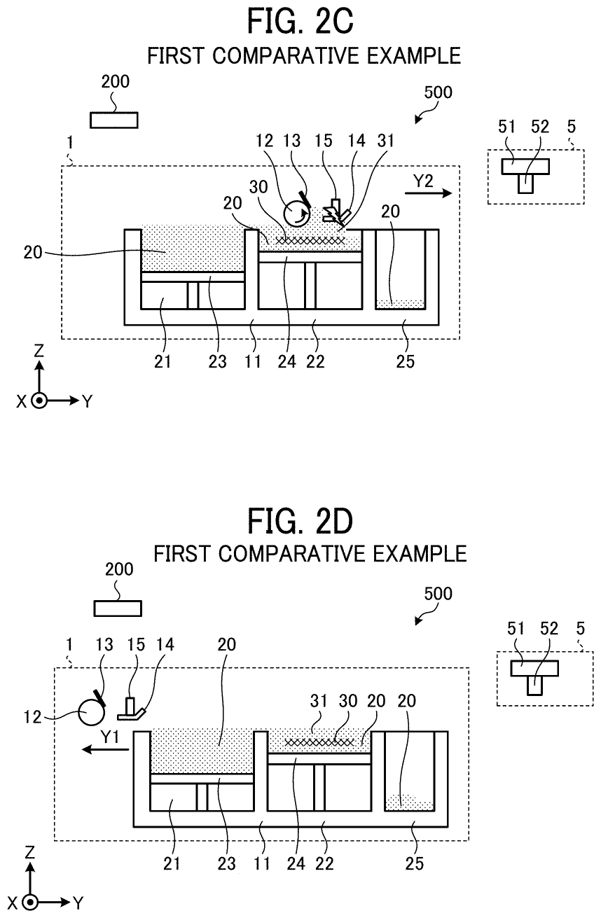

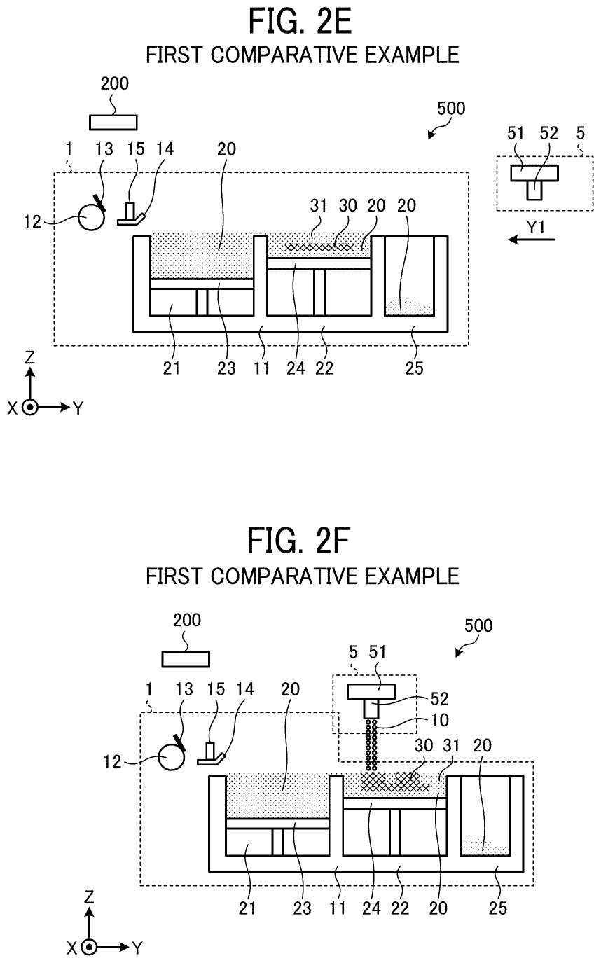

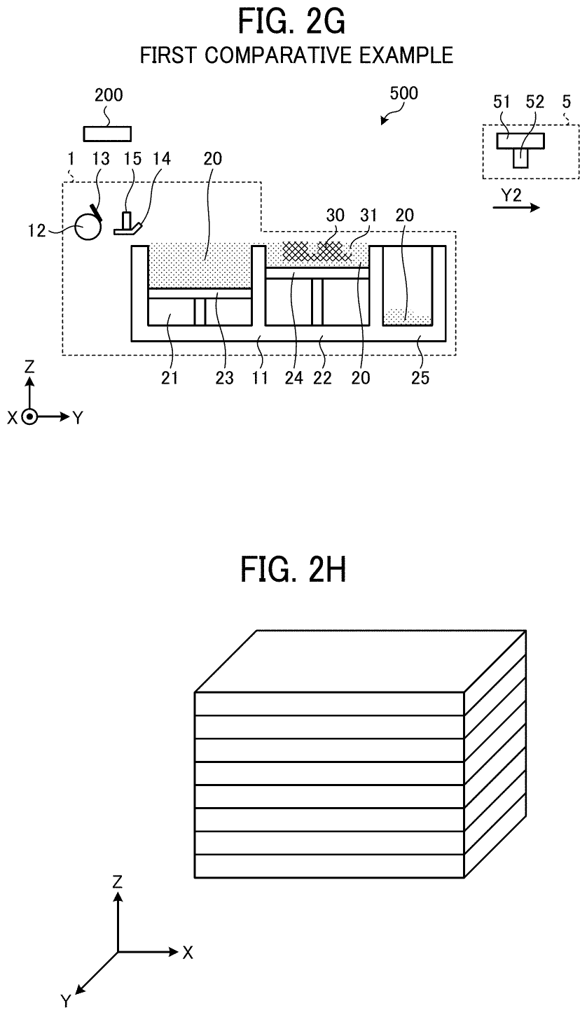

FIGS. 2A to 2G illustrate an example of a flow of fabrication process of the fabrication object in the three-dimensional fabrication apparatus 500 in the first comparative example. FIG. 2H is a schematic perspective view of an example of the fabrication object having a three-dimensional shape fabricated by the three-dimensional fabrication apparatus 500 in the first comparative example. Next, FIGS. 2A to 2G are used to illustrate an example of the flow of fabrication process of the fabrication object in the three-dimensional fabrication apparatus 500.

Here, following description starts from a state in which a first layer of the fabrication layer 30 has been formed on the fabrication stage 24 in the fabrication chamber 22. When a next fabrication layer 30 is formed on the first layer of the fabrication layer 30, as shown in FIG. 2A, the application unit 5 is at an initial position away from the fabrication unit 1 in the Y direction (right direction in FIG. 2A) as illustrated in FIG. 2A.

Then, the three-dimensional fabrication apparatus 500 operates the fabrication unit 1 to raise the supply stage 23 in the supply chamber 21 in the Z direction indicated by arrow Z1 and lower the fabrication stage 24 in the fabrication chamber 22 in the Z direction indicated by arrow Z2 in FIG. 2A.

At this time, the three-dimensional fabrication apparatus 500 sets a lowering distance of the fabrication stage 24 so that a distance between an upper surface of the fabrication chamber 22 (surface of a powder layer 31) and a lower end of the flattening roller 12 (lower tangent portion) becomes a predetermined value. The distance between the upper surface of the fabrication chamber 22 and the lower end of the flattening roller 12 corresponds to a thickness (t) of the powder layer 31 to be formed next. The distance is preferably about several tens μm to about 100 μm.

Next, the three-dimensional fabrication apparatus 500 moves the flattening roller 12 in the Y2 direction indicated by arrow Y2 (rightward direction) toward fabrication chamber 22 while rotating the flattening roller 12 in the forward direction (counterclockwise direction indicated by arrow in FIG. 2B) to transfer and supply the powder 20 disposed above a top surface level of the supply chamber 21 to the fabrication chamber 22 (powder supply operation) as illustrated in FIG. 2B. At this time, the three-dimensional fabrication apparatus 500 vibrates a vibration blade 14.

Further, the three-dimensional fabrication apparatus 500 moves the flattening roller 12 in parallel with the stage surface of the fabrication stage 24 in the fabrication chamber 22 as illustrated in FIG. 2C. Even when the three-dimensional fabrication apparatus 500 moves the flattening roller 12 in parallel with the stage surface of the fabrication stage 24 in the fabrication chamber 22, the three-dimensional fabrication apparatus 500 moves the flattening roller 12 while vibrating the vibration blade 14. Then, the three-dimensional fabrication apparatus 500 stops vibration of the vibration blade 14 when the flattening roller 12 completes movement of the flattening roller 12 above the fabrication chamber 22.

The flattening roller 12 is movable while maintaining a constant distance from an upper surface of the fabrication chamber 22 and the supply chamber 21. The flattening roller 12 is movable while maintaining the constant distance from the upper surface of the fabrication chamber 22 and the supply chamber 21. Such a configuration allows formation of a uniform thickness of the powder layer 31 on the fabrication chamber 22 or the fabrication layer 30 already formed on the fabrication stage 24 while transferring the powder 20 to the fabrication chamber 22 with the flattening roller 12 as illustrated in FIG. 2D.

The three-dimensional fabrication apparatus 500 vibrates the vibration blade 14 to tap the powder 20 to bring the powder 20 into a high-density state. Then, the flattening roller 12 scrapes off excess (surplus) powder 20 so that the three-dimensional fabrication apparatus 500 can form a high-density and flat powder layer 31. After the powder layer 31 is formed, the flattening roller 12 is moved in the Y1 direction (leftward direction) and returned to the initial position as illustrated in FIG. 2D.

Next, the three-dimensional fabrication apparatus 500 moves the application unit 5 in the Y1 direction as illustrated in FIG. 2E. Then, as illustrated in FIG. 2E, the head 52 of the application unit 5 discharges droplets of fabrication liquid 10 onto a predetermined portion of the next powder layer 31 to form and laminate the next fabrication layer 30 on a previous fabrication layer 30 (fabrication operation). The three-dimensional fabrication apparatus 500 performs fabrication operation by moving the head 52 in the X direction (main scanning direction) and the Y direction (sub scanning direction).

For example, the fabrication liquid 10 contains a cross-linking agent. When the fabrication liquid 10 discharged (applied) from the head 52 is mixed with the powder 20, a binding agent contained in the powder 20 is dissolved. The dissolved binding agent is crosslinked and bonded to bond the powder 20 to form the fabrication layer 30.

Similarly, in the fabrication object laminated on an upper part of the fabrication stage 24, a lower surface of an upper layer of the fabrication layer 30 and an upper surface of a lower layer of the fabrication layer 30 are bonded by cross-linking of bonding agent due to permeation of the fabrication liquid supplied to the upper layer of the fabrication layer 30. At this time, a newly formed upper fabrication layer 30 and a preceding lower fabrication layer 30 are united to form a three-dimensional fabrication object.

Next, as illustrated in FIG. 2G, the three-dimensional fabrication apparatus 500 moves the application unit 5 in the Y2 direction to return the application unit 5 to the initial position. Then, the three-dimensional fabrication apparatus 500 completes fabrication operation for one layer. That is, the three-dimensional fabrication apparatus returns to the state illustrated in FIG. 2A. After that, the three-dimensional fabrication apparatus repeats steps of supplying the powder 20, forming the powder layer 31 by flattening, applying the fabrication liquid by the head 52, and the like, to complete to form the fabrication object having three-dimensional shape (three-dimensional fabrication object) as illustrated in FIG. 2H.

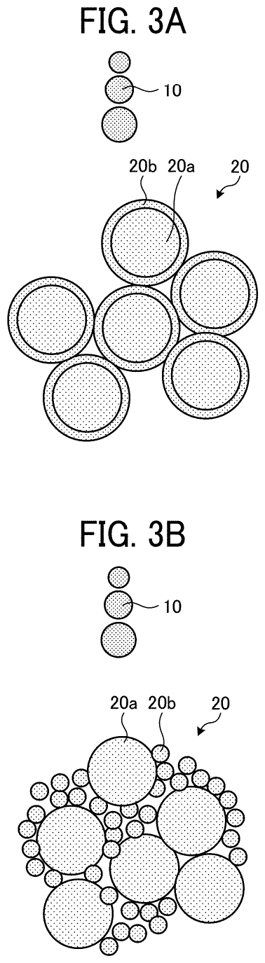

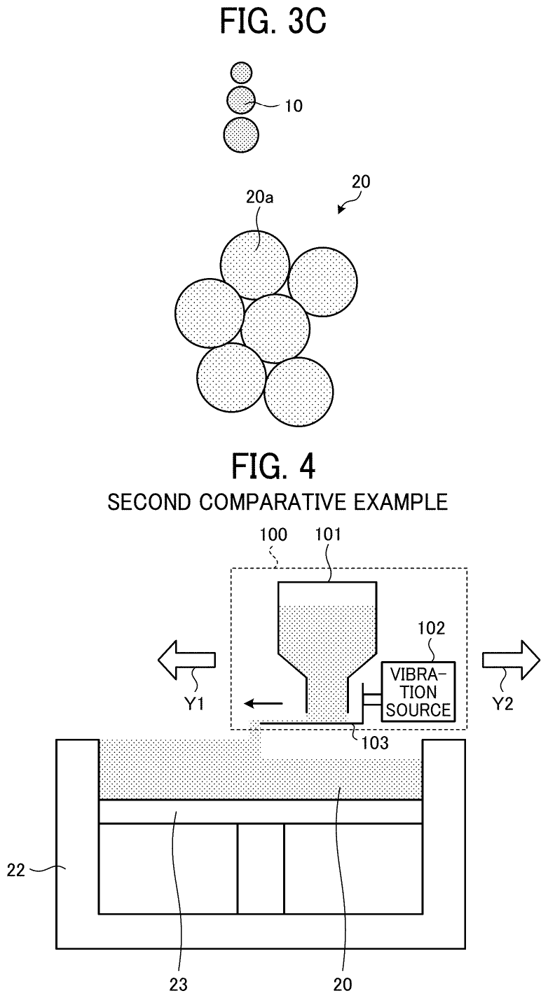

FIGS. 3A to 3C are schematic cross-sectional side view of the powder 20 and the fabrication liquid 10 illustrating an example of the powder 20 used in the fabrication process of the three-dimensional fabrication apparatus 500. Next, an example of the powder 20 used in the fabrication process of the three-dimensional fabrication apparatus 500 is described below with reference to FIGS. 3A to 3C.

As illustrated in FIG. 3A, the powder 20 includes a core 20a (base material) and a binding agent 20b. The core 20a is made of metal or non-metal and has a circular surface. The binding agent 20b is an organic resin binding agent (adhesive) that coats an entire circular surface of the core 20a. As the core 20a, for example, stainless steel powder or glass powder can be applied. As described below, the core 20a becomes a sintered body (final three-dimensional fabrication object) through degreasing sintering. As the organic resin for the binding agent 20b, polyvinyl alcohol, polyacrylic acid and the like may be applied, for example.

Further, as illustrated in FIG. 3B, the binding agent 20b may be mixed with the core 20a instead of coating the core 20a. In the above description, the binding agent 20b is in the powder 20 or mixed with the core 20a, and the fabrication liquid 10 is applied to the powder 20 to form fabrication object. The fabrication liquid 10 crosslinks and bonds the binding agent 20b. However, as illustrated in FIG. 3C, the powder 20 may include only the core 20a without the binding agent 20b, and the fabrication liquid 10 containing the binding agent 20b is applied to the powder 20 to form fabrication object.

FIG. 4 is a schematic side view of a powder supply unit 100 of the three-dimensional fabrication apparatus 500 according to a second comparative example. The powder supply unit 100 is a hopper-type powder supply unit. An example of the hopper-type powder supply unit 100 of the three-dimensional fabrication apparatus 500 according to second comparative example is described below with reference to FIG. 4. The three-dimensional fabrication apparatus 500 in the second comparative example is a powder bed type three-dimensional fabrication apparatus.

A mechanism to supply the powder 20 to the fabrication chamber 22 (powder supply unit 100) in the three-dimensional fabrication apparatus 500 according to the second comparative example is different from the mechanism in the three-dimensional fabrication apparatus 500 according to the first comparative example as illustrated in FIG. 1.

The three-dimensional fabrication apparatus 500 according to the second comparative example is a binder-jetting type three-dimensional fabrication apparatus 500 including head 52 to discharge the fabrication liquid 10.

However, other configurations in the second comparative example are same or similar as the configurations in the first comparative example. Therefore, it is described below the powder supply unit 100 serving as a mechanism to supply the powder 20 to the fabrication chamber 22.

As illustrated in FIG. 4, the powder supply unit 100 is an example of a powder supply unit that supplies the powder 20 to the powder layer 31 in the fabrication chamber 22. Further, as illustrated in FIG. 4, the powder supply unit 100 is movable in the Y1 direction and the Y2 direction. The powder supply unit 100 scans above the fabrication chamber 22 and supplies the powder 20 to the fabrication chamber 22.

The powder supply unit 100 according to the second comparative example includes a hopper 101, a vibration source 102, and a trough 103, as illustrated in FIG. 4. The hopper 101 stores the powder 20 to be supplied to the fabrication chamber 22. The vibration source 102 vibrates the trough 103 described below to supply the powder on the trough 103 to the fabrication chamber 22.

The hopper 101 supplies the powder 20 to the trough 103, and the trough 103 is a supply channel to supply the powder 20 received from the hopper 101 to the fabrication chamber 22. As illustrated in FIG. 4, the trough 103 in the present embodiment preferably has a length (width) in the X direction that is the same as a length (width) of the fabrication chamber 22 in the X direction. As described above, the powder supply unit 100 in the present embodiment moves in the Y1 direction and the Y2 direction to supply the powder 20 to the fabrication chamber 22. Thus, if the length of the trough 103 in the X direction is shorter than the length of the fabrication chamber 22 in the X direction, the powder supply unit 100 has to also move in the X direction to supply the powder 20 to the fabrication chamber 22.

Further, the powder supply unit 100 includes a driver 17 to scan the powder supply unit 100 above the fabrication chamber 22. The driver 17 in the present embodiment moves the powder supply unit 100 in the Y1 direction and the Y2 direction above the fabrication chamber 22 as illustrated in FIG. 4.

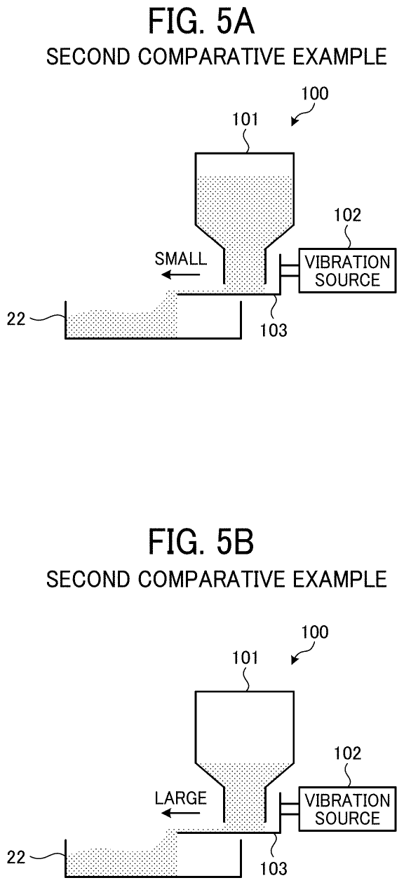

FIGS. 5A and 5B are schematic side views of the powder supply unit 100 illustrating an example of advantages and disadvantages of the hopper-type powder supply unit 100 in the second comparative example. Next, an example of advantages and disadvantages of the hopper-type powder supply unit 100 in the second comparative example is described below with reference to FIGS. 5A and 5B.

First, the advantages of the powder supply unit 100 of the hopper-type powder supply unit 100 is described below.

Since the hopper-type powder supply unit 100 does not require the supply chamber 21, a machine size of the three-dimensional fabrication apparatus 500 can be reduced. Further, the hopper-type powder supply unit 100 can substantially uniformly supply the powder 20 to the fabrication chamber 22 in advance. Thus, the hopper-type powder supply unit 100 can equalize a pressure on a powder surface of fabrication layer 30 in the fabrication chamber 22 at a time of a recoating process.

An amount of powder 20 conveyed by the vibration blade 14 and the flattening roller 12 changes between an upstream side and a downstream side of the fabrication chamber 22 in the Y direction in a two-chamber type three-dimensional fabrication apparatus 500 including the supply chamber 21 and the fabrication chamber 22 as illustrated in FIG. 1. The pressure on the powder surface of the fabrication chamber 22 changes, which causes a variation in a packing density.

Next, the advantages of the powder supply unit 100 of the hopper-type powder supply unit 100 is described below.

In the hopper-type powder supply unit 100, the amount of powder 20 supplied from the powder supply unit 100 to the fabrication chamber 22 variates according to a remaining amount of the powder 20 in the hopper 101 as illustrated in FIGS. 5A and 5B.

In the hopper-type powder supply unit 100, weight of the powder 20 inside the hopper 101 is applied to the trough 103. Therefore, if a large amount of powder 20 is contained in the hopper 101, a large force is applied to the trough 103 to reduce a vibration amplitude of the trough 103. Thus, the amount of powder 20 supplied to the fabrication chamber 22 becomes small as illustrated in FIG. 5A.

Conversely, if only a small amount of powder 20 is contained in the hopper 101, a force applied to the trough 103 decreases to increase the vibration amplitude of the trough 103. Thus, the amount of powder 20 supplied to the fabrication chamber 22 becomes large as illustrated in FIG. 5B. The powder supply unit 100 as illustrated in FIGS. 5A and 5B applies a feeder method.

However, even in the powder supply unit 100 applying a vibration sieving method, the vibration of the trough 103 changes according to the remaining amount of the powder 20 in the hopper 101, and the supply amount of the powder 20 to the fabrication chamber 22 varies as similar to the feeder method. Hereinafter, the “supply amount of the powder 20” is simply referred to as a “powder supply amount”.

Thus, the controller 200 of the three-dimensional fabrication apparatus 500 in the present embodiment measures the powder supply amount of the powder 20 supplied from the powder supply unit 100 to the fabrication chamber 22. The controller 200 is an example of a powder supply amount measurement unit and a controller. The powder supply amount measurement unit is simply referred to as a “measurement unit”.

The controller 200 performs a feedback control of the powder supply amount based on a measurement result of the powder supply amount to reduce a variation in the powder supply amount of the powder 20 in the fabrication chamber 22 from the powder supply unit 100. Thus, the powder supply unit 100 can reduce variations in the supply amount of the powder 20 supplied from the hopper-type powder supply unit 100 to the fabrication chamber 22.

Thus, the powder supply unit 100 can highly accurately control the amount of powder 20 supplied from the hopper 101 to the fabrication chamber 22. For example, the controller 200 measures an amount of powder 20 supplied from the powder supply unit 100 to the fabrication chamber 22 per unit time as the powder supply amount. The controller 200 further performs a feedback control of the powder supply amount based on a measurement result of the powder supply amount to control (reduce) the variation in the supply amount of the powder 20 supplied from the powder supply unit 100 to the fabrication chamber 22.

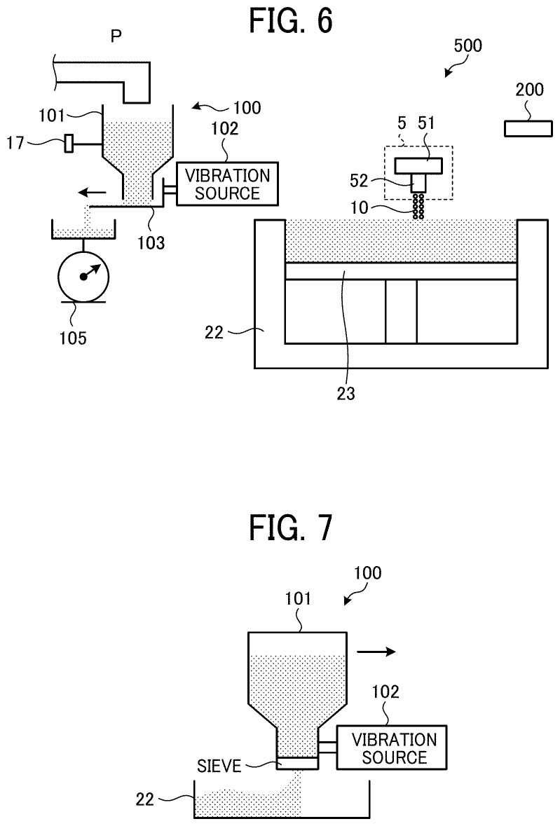

FIG. 6 is a schematic side view of the three-dimensional fabrication apparatus 500 to illustrate an example of measurement process of the powder supply amount in the three-dimensional fabrication apparatus 500 according to the present embodiment. FIG. 7 is a schematic side view of the powder supply unit 100 to illustrate an example of a supply process of the powder 20 to the fabrication chamber 22 in the three-dimensional fabrication apparatus 500 according to the present embodiment.

Next, an example of a feedback control process of the powder supply amount in the three-dimensional fabrication apparatus 500 according to the present embodiment is described with reference to FIGS. 6 and 7.

The three-dimensional fabrication apparatus 500 according to the present embodiment can be applied to a Selective Laser Sintering (SLS) method, a Selective Laser Melting (SLM) method, and the like as long as it is a powder bed type three-dimensional fabrication apparatus 500.

The controller 200 of the three-dimensional fabrication apparatus 500 detects weight of the powder 20 supplied from the powder supply unit 100 in the present embodiment. For example, the controller 200 uses an electronic balance 105 to detect the weight of the powder 20 supplied from the powder supply unit 100 as illustrated in FIG. 6.

The electronic balance 105 serves as an example of a measurement unit to measure the powder supply amount of the powder 20. Then, the controller 200 measures (calculates) the powder supply amount of the powder 20 supplied from the powder supply unit 100 to the fabrication chamber 22 based on the weight of the powder 20 detected by the electronic balance. In the powder supply unit 100 in the present embodiment, the controller 200 uses the electronic balance 105 to measure the powder supply amount of the powder 20 supplied from the powder supply unit 100 to the fabrication chamber 22.

However, the powder supply unit 100 in the present embodiment is not limited to the embodiment using the electronic balance 105. For example, the powder supply unit 100 may also use an optical sensor, ultrasonic waves, electromagnets, impellers, heat detection, and the like to measure the powder supply amount of the powder 20 supplied from the powder supply unit 100 to the fabrication chamber 22.

In the present embodiment, the powder supply unit 100 supplies the powder 20 to the fabrication chamber 22 by a feeder method, but the present embodiment is not limited to the feeder method. For example, the powder supply unit 100 using a vibration sieving method can also be used to supply the powder 20 to the fabrication chamber 22 as illustrated in FIG. 7.

The powder supply unit 100 in FIG. 7 includes the vibration source 102 and a sieve. In the embodiment illustrated in FIG. 7, the powder supply unit 100 uses an ultrasonic element as a vibration source to supply the powder 20 to the fabrication chamber 22. Further, a frequency band of vibration in the vibration sieving method illustrated in FIG. 7 is, for example, in an ultrasonic region.

Thus, the controller 200 of the three-dimensional fabrication apparatus 500 in the present embodiment measures the powder supply amount of the powder 20 supplied from the powder supply unit 100 to the fabrication chamber 22 at timings other than a timing at which the powder 20 is supplied from the powder supply unit 100 to the fabrication chamber 22.

For example, the controller 200 measures the powder supply amount of the powder 20 supplied from the powder supply unit 100 to the fabrication chamber 22 when the powder supply unit 100 is positioned at a standby position P at which the powder supply unit 100 does not supply the powder 20 to the fabrication chamber 22 as illustrated in FIG. 6.

Specifically, the powder supply unit 100 is outside of the fabrication chamber 22 when the powder supply unit 100 positions at the standby position P. In FIG. 6, the powder supply unit 100 is at left side of the fabrication chamber 22.

Thus, the controller 200 can measure the powder supply amount of the powder 20 supplied from the powder supply unit 100 to the fabrication chamber 22 while fabricating the fabrication layer 30 by the application unit 5. Thus, the controller 200 sets a time required for measuring the powder supply amount of the powder 20 supplied from the powder supply unit 100 to the fabrication chamber 22 to be shorter than a fabrication time required for fabricating the fabrication layer 30.

Thus, the controller 200 can efficiently fabricate the three-dimensional object without increasing the fabrication time for fabricating the fabrication layer 30.

Further, the controller 200 of the three-dimensional fabrication apparatus 500 in the present embodiment may measure the powder supply amount of the powder supplied from the powder supply unit 100 to the fabrication chamber 22 when the powder supply unit 100 is at a powder supply position at which the powder 20 is supplied (replenished) to the powder supply unit 100.

That is, the controller 200 measures the powder supply amount of the powder 20 supplied from the powder supply unit 100 to the fabrication chamber 22 while the powder is supplied to the powder supply unit 100 (hopper 101).

Since the powder supply unit 100 is mobile, if the powder 20 necessary for fabricating a fabrication object is supplied (charged) into the hopper 101 at one time, the weight of the powder supply unit 100 increases. Thus, an output of the driver 17 to drive the powder supply unit 100 also increases. An increase of the output of the driver 17 may lead to an increase in a cost of the three-dimensional fabrication apparatus 500. Therefore, it is preferable to load only the minimum necessary amount of the powder 20 in the hopper 101, and the powder 20 is supplied (charged) into the hopper 101 from the powder charging apparatus as needed.

Thus, in a configuration of the three-dimensional fabrication apparatus 500 according to the present embodiment, a measurement position, at which the powder supply amount supplied from the powder supply unit 100 to the fabrication chamber 22 is measured, is set to a powder supply position at which the powder 20 is supplied to the hopper 101. Thus, the measurement time of the powder supply amount needed for measuring the powder supply amount of the powder 20 supplied from the powder supply unit 100 to the fabrication chamber 22 is set to a time shorter than the fabrication time necessary for fabricating the fabrication layer 30.

Thus, the powder supply amount of the powder 20 supplied from the powder supply unit 100 to the fabrication chamber 22 is measured so that it is not necessary to increase a total fabrication time of the fabrication layer 30. Thus, the controller 200 can efficiently fabricate the three-dimensional object.

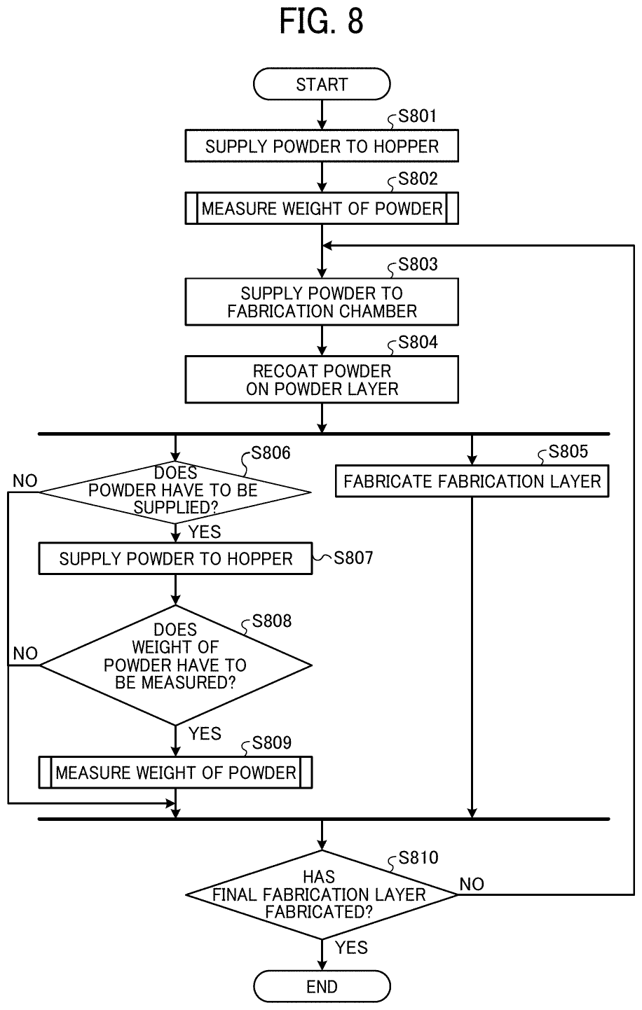

FIG. 8 is a flowchart of an example of a flow of a fabrication process by the three-dimensional fabrication apparatus 500 according to the present embodiment. Next, an example of the flow of the fabrication process by the three-dimensional fabrication apparatus 500 according to the present embodiment is described below with reference to FIG. 8.

First, the controller 200 of the three-dimensional fabrication apparatus 500 supplies (charges) the powder 20 from the powder charging apparatus to the hopper 101 (step S801). Next, the controller 200 uses the electronic balance 105 to measure (detect) the weight of the powder 20 supplied from the powder supply unit 100 to the fabrication chamber 22 when the powder supply unit 100 is positioned at the standby position P (step S802).

Next, the controller 200 controls the driver to move the powder supply unit 100 above the fabrication chamber 22 and controls the powder supply unit 100 to supply the powder 20 from the powder supply unit 100 to the fabrication chamber 22 (step S803).

Further, the controller 200 controls the recoater such as the flattening roller 12 to recoat the powder 20 on the powder layer 31 that has already been laminated in the fabrication chamber 22 (step S804).

Next, the controller 200 fabricates the fabrication layer 30 by the application unit 5 (step S805). At the same time, the controller 200 moves the powder supply unit 100 to the standby position P and determines whether the powder 20 has to be supplied to the hopper 101 (step S806). When the controller determines that the powder 20 has to be supplied to the hopper 101, the controller 200 supplies the powder 20 to the hopper 101 (powder supply unit 100), (step S807).

Then, the controller 200 determines whether the weight of the powder 20 supplied from the powder supply unit 100 has to be measured (step S808). Then, when the controller 200 determines that the weight of the powder 20 supplied from the powder supply unit 100 has to be measured (step S808, Yes), the controller 200 uses the electronic balance 105 to measure the weight of the powder 20 supplied from the powder supply unit 100 (step S809).

The controller 200 of the three-dimensional fabrication apparatus 500 may measure the weight of the powder 20 supplied from the powder supply unit 100 to the fabrication chamber 22 each time the fabrication layer 30 is fabricated for one layer.

The controller 200 may measure the weight of the powder 20 supplied from the powder supply unit 100 to the fabrication chamber 22 after the controller 200 supplies the powder 20 from the powder supply unit 100 to the fabrication chamber 22 a preset number of times.

Alternatively, the controller 200 may measure the weight the powder 20 supplied from the powder supply unit 100 to the fabrication chamber 22 after the powder 20 is supplied from the powder charging device to the hopper 101.

Here, the controller 200 measures the weight of the powder 20 supplied from the powder supply unit 100 to the powder layer 31 in the fabrication chamber 22 after the powder 20 is supplied from the powder charging apparatus to the hopper 101 since a condition of the powder 20 may change due to a supply of the powder 20 from the powder charging apparatus to the hopper 101 so that the powder supply amount of the powder 20 supplied from the powder supply unit 100 to the fabrication chamber 22 may also change.

Thus, the controller 200 measures the weight the powder 20 supplied from the powder supply unit 100 to the fabrication chamber 22 after the powder 20 is supplied from the powder charging apparatus to the hopper 101. Thus, the controller 200 can improve measurement accuracy of the powder supply amount of the powder 20 supplied from the powder supply unit 100 to the fabrication chamber 22. Thus, the controller 200 can highly accurately control the powder supply amount of the powder 20 supplied from the powder supply unit 100 to the fabrication chamber 22.

Next, the controller 200 determines whether the final fabrication layer 30 (final layer) has been fabricated in the fabrication chamber 22 (step S810). When the controller 200 determines that the final fabrication layer 30 has not been fabricated in the fabrication chamber 22 (step S810: No), the controller 200 returns a process to step S803 and supply the powder 20 again from the powder supply unit 100 to the fabrication chamber 22.

On the other hand, when the controller 200 determines that the final fabrication layer 30 has been fabricated in the fabrication chamber 22 (step S810: Yes), the controller 200 ends the fabrication of the fabrication layer 30 to the fabrication chamber 22.

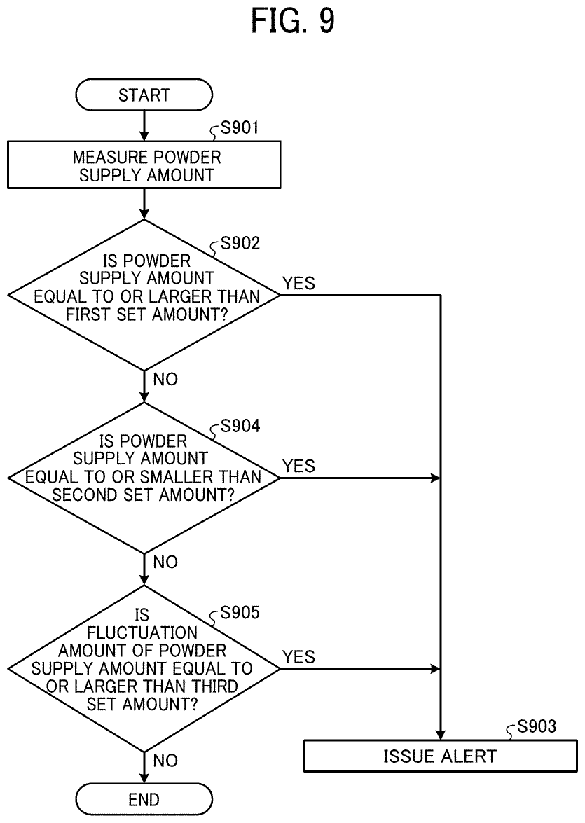

FIG. 9 is a flowchart of an example of a flow of feedback control process of the powder supply amount in the three-dimensional fabrication apparatus 500 in the present embodiment. Next, an example of a feedback control process of the powder supply amount of the powder 20 in the three-dimensional fabrication apparatus 500 according to the present embodiment is described with reference to FIG. 9.

The controller 200 of the three-dimensional fabrication apparatus 500 measures the powder supply amount of the powder 20 supplied from the powder supply unit 100 to the fabrication chamber 22 based on the weight of the powder 20 supplied from the powder supply unit 100 to the fabrication chamber 22 (step S901).

Next, the controller 200 calculates the powder supply amount of the powder 20 per layer of the powder layer 31 in the fabrication chamber 22 and determines whether a calculated powder supply amount is equal to or larger than a first set amount (step S902).

When the calculated powder supply amount is equal to or larger than the first set amount (step S902: Yes), the controller 200 as an example of an alert transmission unit issues an alert (step S903). Thus, the controller 200 can detect a malfunction of the powder supply unit 100 (feeder), overflow of powder 20 from the hopper 101, and damage to the vibration source of the powder supply unit 100 of the vibration sieving method.

Here, the first set amount is preferably a target powder supply amount that is the powder supply amount of the powder 20 necessary for fabricating the powder layer 31 per one layer. The controller 200 preferably controls an amount of powder 20 measured when the powder supply amount of the powder 20 supplied from the powder supply unit 100 to the fabrication chamber to be small. The controller 200 supplies the powder 20 that exceeds the target powder supply amount per one layer of the fabrication layer 30 to the fabrication chamber 22 when an abnormality has occurred in the powder supply unit 100.

When the calculated powder supply amount is smaller than the first set amount (step S902: No), the controller 200 determines whether the calculated powder supply amount is equal to or smaller than the second set amount (step S904). When the calculated powder supply amount is equal to or smaller than the second set amount (step S904: Yes), the controller 200 issues an alert (step S903).

Thus, the controller 200 can detect that an empty interior of the hopper 101, clogging of the powder 20 in the hopper 101, malfunction of the powder supply unit 100 (feeder), clogging sieve in powder supply unit 100 of the vibration sieve method, and the like. The second set amount is preferably about half of the target powder supply amount.

When the calculated powder supply amount exceeds the second set amount (step S904: No), the controller 200 determines whether a difference between a previously calculated powder supply amount and a currently calculated powder supply amount is equal to or larger than a third set amount (step S905). The difference is an amount of fluctuation (fluctuation amount) of the calculated powder supply amount.

When the fluctuation amount of the powder supply amount is equal to or larger than the third set amount (step S905: Yes), the controller 200 issues an alert (step S903). Thus, the controller 200 can detect a change in characteristics of the powder 20 supplied from the powder supply unit 100. Here, the third set amount is preferably set based on a standard deviation of the fluctuation amount of the powder supply amount of the powder 20.

After issuance of an alert in step S903, the controller 200 of the three-dimensional fabrication apparatus 500 feeds back the powder supply amount based on the measurement result of the powder supply amount of the powder 20 supplied from the powder supply unit 100 to the powder layer 31. The controller 200 in the present embodiment controls a supply time of the powder 20 supplied from the powder supply unit 100 to the fabrication chamber 22 based on the measurement result of the powder supply amount of the powder 20 supplied from the powder supply unit 100 to the fabrication chamber 22.

The third set amount is an example of a preset amount used for the feedback control of the controller 200. The controller 200 (circuitry) performs the feedback control to control the fluctuation amount of the powder supply amount to be smaller than the third set amount (preset amount) based on a measurement result of the powder supply amount by the electronic balance 105 as a measurement unit.

Specifically, the controller 200 controls the supply time based on the target powder supply amount and the measurement result of the powder supply amount. For example, the controller 200 sets the supply time to ten second when the target powder supply amount is 100 g, and the measured powder supply amount (supply amount of the powder 20 supplied from the powder supply unit 100 to the powder layer 31 per unit time) is 10 g/s.

When the measured powder supply amount changes to 9 g/s, the controller 200 sets the supply time to 11.1 second. Thus, the controller 200 can bring the powder supply amount of the powder 20 supplied from the powder supply unit 100 to be close to the target powder supply amount.

Thus, the controller 200 can highly accurately supply the target powder supply amount of the powder 20 to fabrication chamber 22

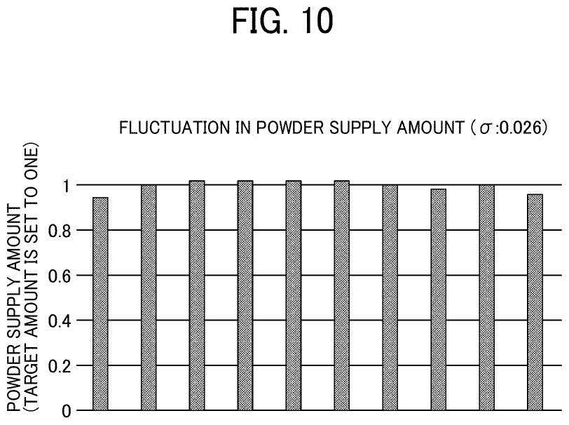

FIG. 10 is a graph illustrating an example of a calculation result of the powder supply amount of the powder 20 by the three-dimensional fabrication apparatus 500 according to the present embodiment.

In FIG. 10, a vertical axis represents the calculation result of the powder supply amount of the powder 20 per one layer of the powder layer 31 when the target powder supply amount (target amount) is set to one, and a horizontal axis represents a time. Further, it is assumed that the standard deviation σ of the calculation result of the powder supply amount of the powder 20 illustrated in FIG. 10 is 0.026.

Next, an example of an abnormality detection process of the powder supply amount of the three-dimensional fabrication apparatus 500 according to the present embodiment is described with reference to FIG. 10.

As described above, the standard deviation σ of the calculation result of the powder supply amount of the powder 20 illustrated in FIG. 10 is 0.026.

There is an abnormality in supply of the powder 20 from the powder supply unit 100 when the calculation result of the powder supply amount becomes half of the target powder supply amount based on the target powder supply amount. When the powder supply amount of the powder 20 becomes half of the target powder supply amount, a time taken for supplying the powder 20 to the fabrication chamber 22 increases.

Thus, a time of fabrication process required for fabricating the fabrication layer 30 increases. Therefore, the controller 200 in the present embodiment controls the second set amount to about half of the target powder supply amount. When the powder supply amount of the powder 20 per one layer of the fabrication layer 30 is equal to or smaller than the second set amount, the controller 200 issues an alert and performs feedback control of the powder supply amount.

Further, the controller 200 of the three-dimensional fabrication apparatus 500 in the present embodiment sets the third set amount to 3σ that is three times the standard deviation σ of the calculation result of the powder supply amount of the powder 20. When the fluctuation amount of the powder supply amount of the powder 20 is 3σ or more, the controller 200 issues an alert and performs feedback control of the powder supply amount.

As described above, the three-dimensional fabrication apparatus 500 according to the present embodiment can control the fluctuation in the powder supply amount of the powder 20 from the hopper-type powder supply unit 100 to the fabrication chamber 22. Thus, the controller 200 can highly accurately control the powder supply amount of powder 20 supplied from the hopper 101 to the fabrication chamber 22.

Therefore, the three-dimensional fabrication apparatus 500 according to the present embodiment can highly accurately control the powder supply amount of the powder 20 from the hopper 101 to the fabrication chamber 22 when the powder 20 is supplied from the hopper 101 to the fabrication chamber 22 of the three-dimensional fabrication apparatus 500 and the like.

Each of the functions of the controller 200 in the above-described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

Numerous additional modifications and variations are possible in light of the above teachings. It is therefore to be understood that, within the scope of the above teachings, the present disclosure may be practiced otherwise than as specifically described herein. With some embodiments having thus been described, it is obvious that the same may be varied in many ways. Such variations are not to be regarded as a departure from the scope of the present disclosure and appended claims, and all such modifications are intended to be included within the scope of the present disclosure and appended claims.

What is claimed is:

1. A three-dimensional fabrication apparatus comprising:
a fabrication chamber in which a fabrication object is formed;
a powder supply unit configured to supply powder to the fabrication chamber;
a driver configured to scan the powder supply unit above the fabrication chamber;
a measurement unit configured to measure a powder supply amount, the powder supply amount being an amount of the powder supplied from the powder supply unit to the fabrication chamber; and
circuitry configured to perform a feedback control to control a fluctuation amount of the powder supply amount to be smaller than a preset amount based on the powder supply amount measured by the measurement unit.

2. The three-dimensional fabrication apparatus according to claim 1,
wherein the circuitry is configured to control the measurement unit to measure the powder supply amount at timings other than a timing at which the powder supply unit supplies the powder to the fabrication chamber.

3. The three-dimensional fabrication apparatus according to claim 1,
wherein the measurement unit measures weight of the powder supplied from the powder supply unit; and
the circuitry is configured to calculate the powder supply amount based on the weight measured by the measurement unit.

4. The three-dimensional fabrication apparatus according to claim 1,
wherein the powder supply unit includes a hopper configured to supply the powder to the fabrication chamber by a feeder method.

5. The three-dimensional fabrication apparatus according to claim 1,
wherein the powder supply unit includes a vibration source and a sieve, to supply the powder to the fabrication chamber by a vibration sieving method.

6. The three-dimensional fabrication apparatus according to claim 5,
wherein a frequency band of vibration of the vibration source is in an ultrasonic region.

7. The three-dimensional fabrication apparatus according to claim 1,
wherein the circuitry is configured to:
control the measurement unit to measure the powder supply amount when the powder supply unit positions at a standby position outside the fabrication chamber.

8. The three-dimensional fabrication apparatus according to claim 1,
wherein the circuitry is configured to:
control the measurement unit to measure the powder supply amount when the powder supply unit positions at a supply position at which the powder is to be supplied to the powder supply unit.

9. The three-dimensional fabrication apparatus according to claim 1, further comprising:
an alert transmission unit configured to issue an alert,
wherein the circuitry is configured to:
control the alert transmission unit to issue the alert when the powder supply amount per one layer of a powder layer in the fabrication chamber becomes equal to or larger than a first set amount.

10. The three-dimensional fabrication apparatus according to claim 9,
wherein the circuitry is configured to:
control the alert transmission unit to issue the alert when the powder supply amount per one layer of the powder layer in the fabrication chamber becomes equal to or smaller than a second set amount smaller than the first set amount.

11. The three-dimensional fabrication apparatus according to claim 10,
wherein the circuitry is configured to:
control the alert transmission unit to issue the alert when the fluctuation amount of the powder supply amount per one layer of the powder layer in the fabrication chamber becomes equal to or larger than a third set amount.

12. The three-dimensional fabrication apparatus according to claim 1, further comprising:
an application unit including a head configured to discharge a liquid onto a powder layer in the fabrication chamber to form a fabrication layer of the fabrication object.

13. The three-dimensional fabrication apparatus according to claim 1,
wherein the powder supply amount is the amount of the powder supplied from the powder supply unit to the fabrication chamber per unit time.
